(19) United States
(12) Patent Application Publication
(10) Pub. No.: US 2015/0321592 A1
(43) Pub. Date: Nov. 12, 2015

(54) TRAY TABLE ASSEMBLY

(71) Applicant: Zodiac Seats France, Issoudun (FR)

(72) Inventor: Jose Bernardo De Morais, Chateauroux (FR)

(21) Appl. No.: 14/388,333

(22) PCT Filed: Mar. 26, 2013
(86) PCT No.: PCT/IB2013/052407

§ 371 Date: Sep. 26, 2014

Related U.S. Application Data
(60) Provisional application No. 61/615,421, filed on Mar. 26, 2012.

(51) Int. Cl. B60N 3/00; A47B 31/06; B64D 11/06; A47B 5/00

(52) U.S. Cl. CPC B60N 3/002; A47B 5/006; A47B 31/06; B64D 11/0641

(57) ABSTRACT

Described are tray table assemblies having a table body (12), a support arm (14) comprising a support portion (18) coupled to the table body and a coupling portion (20), a center console (44) comprising a table storage compartment (52) and a track (44), wherein the track (44) is located between the table storage compartment (52) and a location forward of the table storage compartment, and the table storage compartment (52) is located above an armrest support (42), and a linkage comprising a head (28) and a base (30), wherein the head (28) is rotatably coupled to the coupling portion (29) of the support arm (14), and the base (30) is slidingly coupled to the track (40). The table body may configured to slide between a stowed position within the table storage compartment to a raised position and to rotate between the raised position and a deployed position forward of a passenger seat.

### CROSS REFERENCE TO RELATED APPLICATION

This application is related to and claims priority benefits from U.S. Provisional Application Ser. No. 61/615,421, filed on Mar. 26, 2012, entitled VERTICALLY STORED TRAY TABLE (“the '421 application”). The '421 application is hereby incorporated herein in its entirety by this reference.

### FIELD OF THE INVENTION

The invention relates to tray tables for passenger seats or the like.

### BACKGROUND

Many passenger seats such as those on passenger aircraft, buses, trains, and the like are equipped with upright positions and full flat or a lie flat bed position. These seats comprise at least a bottom cushion, a back cushion, and armrests.

In an upright position, the top of the bottom cushion is typically located between 15-19 inches from the floor, and the top of the armrests is located at approximately 25 inches from the floor.

In an sleeper position, the top of the bottom cushion is generally at the same level, and the body of the passenger is located just below and/or adjacent the armrest.

Many seats are double or triple units, with a center console between each seat. The center console serves many functions: separation between passenger living space, armrest support, food tray stowage compartment, and/or location for a drink tray.

Typically, a tray table stowage compartment is located inside the center console, below the armrest or in front of the center console below the drink tray. These stowage locations are limiting to the amount of room available for a passenger when the passenger seat is in the sleeper position.

In certain situations, it may be desirable to maximize the amount of space available to passengers when the passenger seat is in the sleeper position by relocating the tray table stowage compartment to a location above the armrest and/or by retracting at least one of the armrests.

### SUMMARY

Embodiments of the present invention include a tray table assembly comprising a table body, a support arm comprising a support portion coupled to the table body and a coupling portion, a center console comprising a table storage compartment and a track, wherein the track is located between the table storage compartment and a location forward of the table storage compartment, and the table storage compartment is located above an armrest support, and a linkage comprising a head and a base, wherein the head is rotatably coupled to the coupling portion of the support arm, and the base is slidingly coupled to the track, wherein the table body is configured to slide between a stowed position within the table storage compartment to a raised position in the location forward of the table storage compartment, and an outer surface of the table body is substantially vertically oriented in the stowed and raised positions, and wherein the table body is configured to rotate between the raised position and a deployed position forward of a passenger seat, and the outer surface of the table body is substantially horizontally oriented in the deployed position.

In certain embodiments, the center console further comprises a drink tray located forward of the raised position, and the table body may be configured not to contact the drink tray. A retractable armrest may be positioned proximate a seat back, and a control panel may be located on the head of the linkage.

According to certain embodiments, the track is located below an upper surface of the armrest support. In some embodiments, the passenger seat comprises additional width when positioned in a sleeper position.

### BRIEF DESCRIPTION OF THE DRAWINGS

FIG. 1 is a perspective view of passenger seats with tray table assemblies according to certain embodiments of the present invention, with one tray table assembly in a stowed position and a second tray table assembly in a deployed position.

FIG. 2 is a perspective view of passenger seats with the tray table assemblies of FIG. 1, with one of the passenger seats in a sleeper position, one tray table assembly in a stowed position, and a second tray table assembly in a deployed position.

FIG. 3 is a perspective view of a passenger seat with the tray table assembly of FIG. 1 in a deployed position.

FIG. 4 is a perspective view of a passenger seat with the tray table assembly of FIG. 1 in a raised position.

FIG. 5 is a perspective view of a passenger seat with the tray table assembly of FIG. 1, showing the rotational movement of the tray table assembly between raised and deployed positions.

### DETAILED DESCRIPTION

The described embodiments of the invention provide tray table assemblies for use with passenger seats. While the tray table assemblies are discussed for use with aircraft seats, they are by no means so limited. Rather, embodiments of the tray table assemblies may be used in passenger seats or other seats of any type or otherwise as desired.

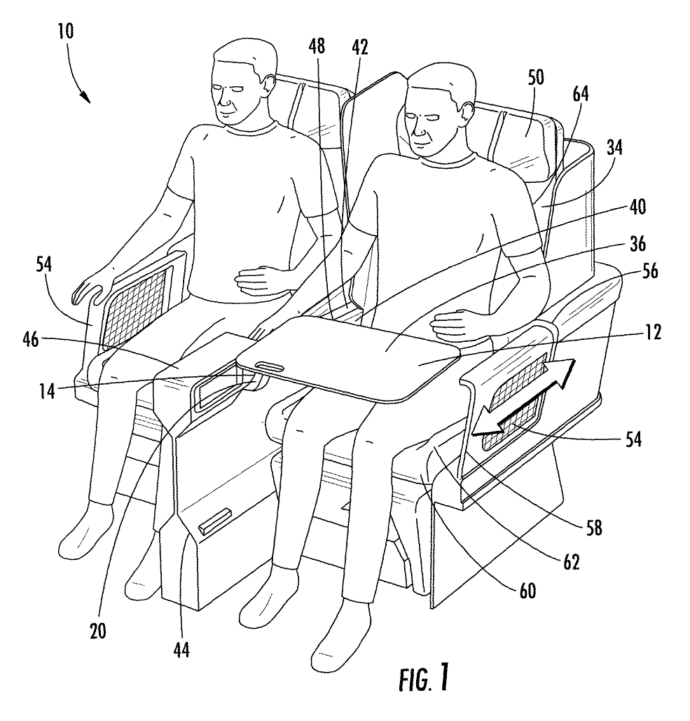

FIGS. 1-5 illustrate embodiments of a tray table assembly 10. In these embodiments, the tray table assembly 10 comprises at least a table body 12, a support arm 14, and a linkage 16.

The table body 12 may be formed of materials including but not limited to aluminum, stainless steel, aramid fibers, polycarbonate, polypropylene, other plastic materials, other metallic materials, composite materials, or other similar materials. One of skill in the art will understand that any suitable materials may be used to form the table body 12 that will provide a lightweight table body 12 having sufficient strength to withstand forces that may be placed on the tray table assembly 10.

The support arm 14 and the linkage 16 may be formed of constructed of any suitable material including but not limited to aluminum, stainless steel, other metallic materials, composite materials, or other similar materials that provides sufficient strength to withstand forces that may be placed on the tray table assembly 10.

In some embodiments, as illustrated in FIGS. 1-5, the table body 12 may have a polygonal shape. For example, as shown in FIGS. 1-5, the table body 12 has a hexagonal shape so as to eliminate projecting corners in at least two locations. However, one of ordinary skill in the relevant art will understand that the table body 12 may have any suitable shape including but not limited to rectilinear, trapezoidal, parabolic, or other suitable shape. The table body 12 may be integrally formed as a single piece, as shown in FIGS. 1-5, or may include multiple segments that are coupled to one another to form the table body 12.

In some embodiments, as shown in FIGS. 1-5, the support arm 14 comprises a support portion 18 and a coupling portion 20. In certain embodiments, the support portion 18 is substantially planar and may be configured to be positioned adjacent at least a portion of an underside 22 of the table body 12 to provide structural support to the table body 12 in a deployed position (as discussed in more detail below). In embodiments where the table body 12 comprises multiple segments, the support portion 18 may be configured to be positioned adjacent at least a portion of the underside 22 of either or both segments in the deployed position.

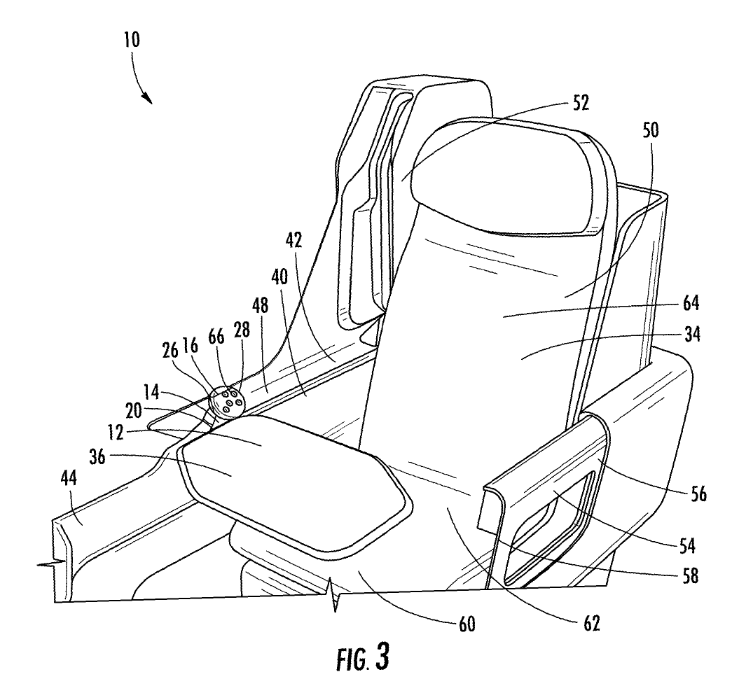

The coupling portion 20 may be coupled to or integrally formed with an end 24 of the support portion 18. In some embodiments, as illustrated in FIGS. 3-5, the coupling portion 20 may comprise an aperture 26 that is configured to rotatably couple to a head 28 of the linkage 16. In some embodiments, the coupling portion 20 is shaped to extend from the end 24 of the support portion 18 at an angle or direction that positions the aperture 26 proximate an aft corner of the table body 12.

The linkage 16 may further comprise a base 30 coupled to or integrally formed with the head 28. In certain embodiments, the head 28 may comprise a cross-sectional area having a circular shape so that the head 28 may have a conical or cylindrical three-dimensional shape and any suitable shape that allows the coupling portion 20 to rotate relative to the head 28. The head 28 is therefore configured to extend through the aperture 26 so that the coupling portion 20 rotates about the head 28. The head 28 may be oriented at any suitable angle relative to the base 30 so as to achieve the desired plane of rotation of the table body 12.

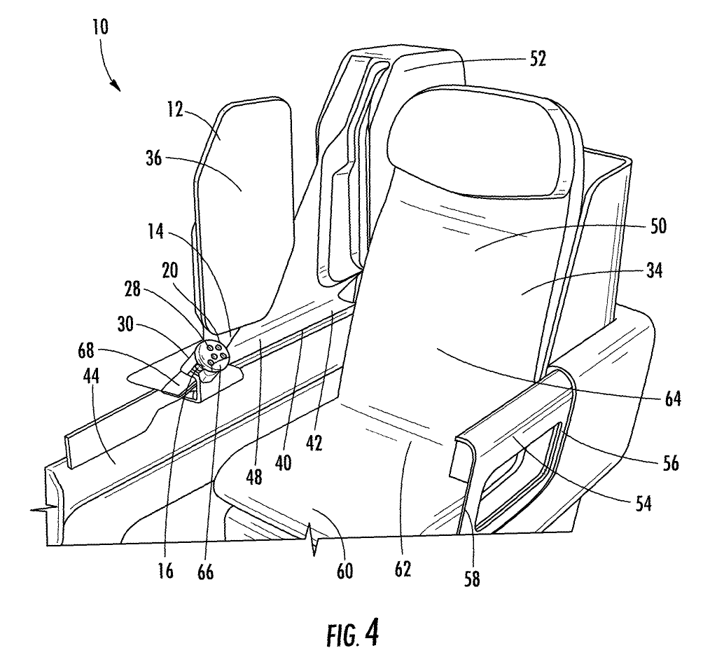

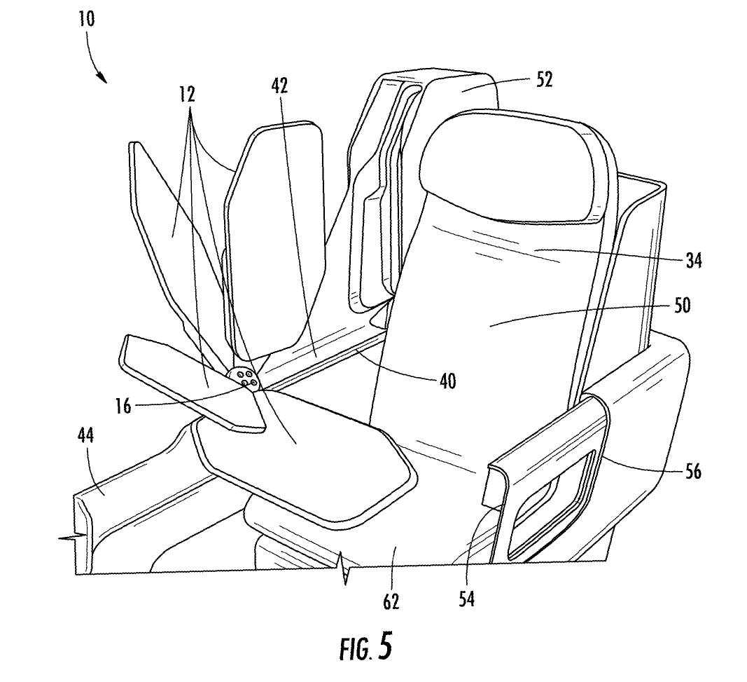

The combined orientation of the head 28 and/or the shape of the coupling portion 20 control the rotational pattern of the table body 12. Specifically, as illustrated in FIG. 5, the table body 12 rotates between a raised position where the table body 12 is positioned with an outer surface 36 in a substantially vertical orientation proximate one side of a passenger seat 34 (as shown in FIG. 4) to a deployed position where the table body 12 is positioned with the outer surface 36 in a substantially horizontal orientation forward of the passenger seat 34 (as shown in FIG. 5).

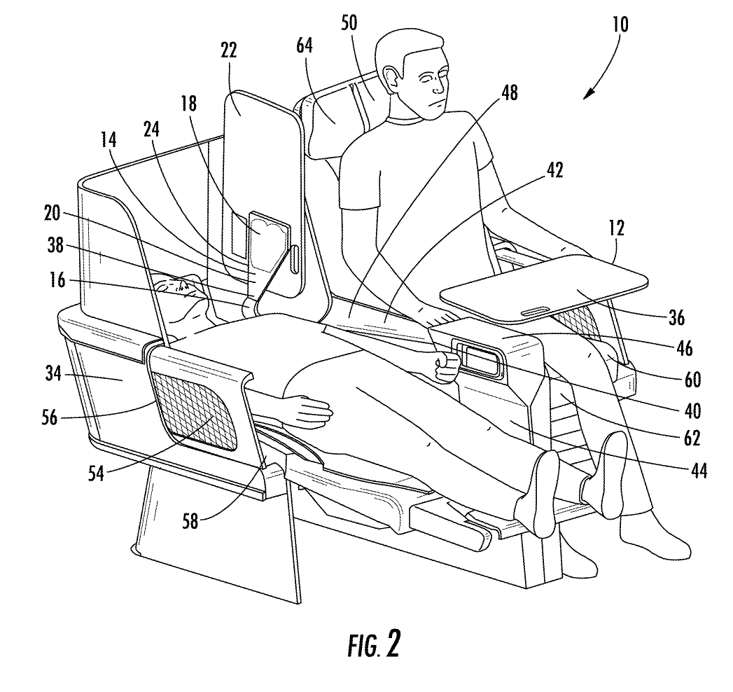

In some embodiments, as shown in FIGS. 1-2, the coupling portion 20 may comprise a hinge 38 that is pivotally coupled to the linkage 16. In these embodiments, the table body 12 is configured to pivot in a transverse direction relative to the passenger seat 34. Specifically, the table body 12 pivots between a raised position where the table body 12 is positioned with the outer surface 36 in a substantially vertical orientation proximate one side of the passenger seat 34 (similar to the position of the table body 12 shown in FIG. 4) and a deployed position where the table body 12 is positioned with the outer surface 36 in a substantially horizontal orientation forward of the passenger seat 34 (as shown on the right-hand side of FIGS. 1-2).

In the embodiments shown in FIGS. 1-5, the base 30 of the linkage 16 may be slidingly coupled to a track 40 located on and/or coupled to a center console 44. The track 40 may be located between a table storage compartment 52 and a location forward of the table storage compartment 52. The table storage compartment 52 and/or the track 40 may be located adjacent to and/or above an armrest support 42. In certain embodiments, the center console 44 further comprises a drink tray 46 located forward of the raised position.

In certain embodiments, as illustrated in FIGS. 1-5, the track 40 may be located below an upper surface 48 of the armrest support 42, and the base 30 may have a “U” shape or other shape that allows the base 30 to extend around the upper surface 48 of the armrest support 42 and slidingly connect to the track 40. One or more tracks 40 may be positioned on one or both sides of the armrest support 42. In certain embodiments, the track 40 may include electrical connections that provide power and communication to a control panel 66 that may be mounted on the head 28.

The table body 12 slides along the track 40 between the raised position where the table body 12 is positioned with the outer surface 36 in a substantially vertical orientation proximate one side of the passenger seat 34 (as shown in FIG. 4) to a stowed position where the table body 12 is positioned above the armrest support 42 and proximate and/or aft of a seat back 50 of the passenger seat 34 (as shown on the left-hand side of FIGS. 1-2).

A stop 68 may be provided adjacent a forward end of the track 40 that corresponds to the raised position of the table body 12 described above. The stop 68 prevents the table body 12 from traveling forward beyond the raised position location and contacting or interfering with the drink tray 46.

In the stowed position described above, the table body 12 may be housed within the table storage compartment 52. The table storage compartment 52 is configured to have a volume that accommodates substantially all of the surface area and the height of the table body 12 in the stowed position. For example, in some embodiments, the table storage compartment 52 may be configured to house the table body 12 in an unfolded configuration, such as in the examples where the table body 12 is formed as an integral piece. In embodiments where the table body 12 comprises multiple segments that are folded over one another for stowage, the table storage compartment 52 may include a wider opening to accommodate a greater thickness of the folded table body 12 and a smaller height to accommodate a shorter vertical dimension of the folded table body 12. One of ordinary skill in the relevant art will understand that any suitable configuration of height and depth of the table storage compartment 52 may be used that will fit within appropriate space above and/or within the center console 44.

The shape of the head 28, the coupling portion 20, the shape of the table body 12 and/or the location of the stop 68 result in a rotational design for the tray table assembly 10 that is easily deployed and stowed, while also avoiding contact with the drink tray 46 or objects that may be placed on the drink tray 46 to prevent unintentional spills or accidents.

Furthermore, by locating the table storage compartment 52 and the track 40 approximately level with or above the armrest support 42, additional width is provided for a passenger when the passenger seat 34 is in a sleeper position.

The embodiments illustrated in FIGS. 1-5 include a double seat unit with a single center console 44 located between the passenger seats 34. Other embodiments are configured for use with a triple seat unit. In the triple seat unit, a center seat is located between two center consoles 44. One of the center consoles 44 will include tray table assemblies 10, such as the center console 44 shown in FIGS. 1-5. The other center console 44 will include one tray table assembly 10.

The passenger seat 34 may further comprise a retractable armrest 54 positioned opposite the location of the armrest support 42. The armrest 54 is slidingly coupled to a track 56 or other guiding means positioned proximate and/or aft of the seat back 50 of the passenger seat 34. The armrest 54 may slide to a deployed position where a forward edge 58 of the armrest 54 is positioned proximate a forward edge 60 of a lower cushion 62 of the passenger seat 34 when the passenger seat 34 is in an upright position. In the deployed position, the armrest 54 provides privacy to a passenger, as well as support for the passenger's arm.

In contrast, the armrest 54 may slide to a retracted position where the forward edge 58 of the armrest 54 is positioned proximate a forward surface 64 of the seat back 50 of the passenger seat 34 when the passenger seat 34 is in an upright position. In the retracted position, better access to the passenger seat 34 is available for handicapped access and/or for passengers requiring additional space to access the passenger seat 34. The retracted position also provides additional width for a passenger when the passenger seat 34 is in a sleeper position.

The foregoing is provided for purposes of illustrating, explaining, and describing embodiments of the present invention. Further modifications and adaptations to these embodiments will be apparent to those skilled in the art and may be made without departing from the scope or spirit of the invention.

That which is claimed is:

1. A tray table assembly comprising:
(a) a table body;
(b) a support arm comprising support portion coupled to the table body, and a coupling portion;
(c) a center console comprising a table storage compartment and a track, wherein the track is located between the table storage compartment and a location forward of the table storage compartment, and the table storage compartment is located above an armrest support; and
(d) a linkage comprising a head and a base, wherein the head is rotatably coupled to the coupling portion of the support arm, and the base is slidingly coupled to the track;
wherein the table body is configured to slide between a stowed position within the table storage compartment to a raised position in the location forward of the table storage compartment, and an outer surface of the table body is substantially vertically oriented in the stowed and raised positions, and
wherein the table body is configured to rotate between the raised position and a deployed position forward of a passenger seat, and the outer surface of the table body is substantially horizontally oriented in the deployed position.

2. The tray table assembly of claim 1, wherein the center console further comprises a drink tray located forward of the raised position.

3. The tray table assembly of claim 2, wherein the table body is configured not to contact the drink tray.

4. The tray table assembly of claim 1, further comprising a retractable armrest positioned proximate a seat back.

5. The tray table assembly of claim 1, further comprising a control panel located on the head of the linkage.

6. The tray table assembly of claim 1, wherein the track is located below an upper surface of the armrest support.

7. The tray table assembly of claim 1, wherein the passenger seat comprises additional width when positioned in a sleeper position.

8. A passenger seat comprising:
(a) a tray table assembly comprising:
(i) a table body;
(ii) a support arm coupled to the table body;
(iii) a linkage comprising a head rotatably coupled to the support arm and a base; and
(b) a center console comprising a table storage compartment and a track, wherein the track is located between the table storage compartment and a location forward of the table storage compartment, and the base of the linkage is slidingly coupled to the track; and
(c) a retractable armrest positioned proximate a seat back;
wherein the table body is configured to slide between a stowed position within the table storage compartment to a raised position in the location forward of the table storage compartment, and an outer surface of the table body is substantially vertically oriented in the stowed and raised positions, and
wherein the table body is configured to rotate between the raised position and a deployed position, and the outer surface of the table body is substantially horizontally oriented in the deployed position.

9. The passenger seat of claim 8, wherein the center console further comprises a drink tray located forward of the raised position.

10. The passenger seat of claim 9, wherein the table body is configured not to contact the drink tray.

11. The passenger seat of claim 8, further comprising a control panel located on the head of the linkage.

12. The passenger seat of claim 8, wherein the table storage compartment is located above an armrest support, and the track is located below an upper surface of the armrest support.

13. The passenger seat of claim 8, wherein the passenger seat comprises additional width when positioned in a sleeper position.

14. A method of deploying a tray table assembly, the tray table assembly comprising (i) a table body, (ii) a support arm comprising a support portion coupled to the table body and a coupling portion, (iii) a center console comprising a track located between a table storage compartment and a location forward of the table storage compartment, and (iv) a linkage comprising a head rotatably coupled to the coupling portion of the support arm and a base slidingly coupled to the track, the method comprising:
(a) sliding the table body from a stowed position within the table storage compartment to a raised position, wherein an outer surface of the table body is substantially vertically oriented in the stowed and raised positions; and
(b) rotating the table body around the head of the linkage until the outer surface of the table body is substantially horizontally oriented in a deployed position.

15. The method of claim 14, wherein the center console further comprises a drink tray located forward of the raised position.

16. The method of claim 15, wherein the table body is configured not to contact the drink tray.

17. The method of claim 14, further comprising a retractable armrest positioned proximate a seat back.

18. The method of claim 17, the method further comprising the step of sliding the retractable armrest from a deployed position, wherein a forward edge of the retractable armrest is positioned proximate a forward edge of a lower cushion of a passenger seat when the passenger seat is in an upright position, to a retracted position, wherein the forward edge of the retractable armrest is positioned proximate a forward surface of the seat back of the passenger seat when the passenger seat is in the upright position.

19. The method of claim 14, further comprising a control panel located on the head of the linkage.

20. The method of claim 14, wherein the table storage compartment is located above an armrest support, and the track is located below an upper surface of the armrest support.
